(19) United States
(12) Patent Application Publication
(10) Pub. No.: US 2026/0163273 A1
(43) Pub. Date: Jun. 11, 2026

(54) ELECTRICAL CONNECTION APPARATUS

(71) Applicant: SAMSUNG SDI CO., LTD., Yongin-si (KR)

(72) Inventor: PEELSIK JEON, Yongin-si (KR)

(21) Appl. No.: 19/413,169

(22) Filed: Dec. 9, 2025

(30) Foreign Application Priority Data
Dec. 10, 2024 (KR) 10-2024-0183084

(51) Int. Cl. H01R 12/75; H01R 13/207

(52) U.S. Cl. CPC H01R 12/75; H01R 13/207; H01R 2201/26

(57) ABSTRACT

An electrical connection apparatus includes a plurality of pins configured to be inserted into holes formed in a circuit board. A plurality of terminals are electrically connected to the plurality of pins. A housing supports the pins and the terminals. A pin connection conductor electrically connects two or more pins of the pins.

### CROSS-REFERENCE TO RELATED APPLICATION

The present application claims priority to and the benefit of Korean Patent Application No. 10-2024-0183084, filed on Dec. 10, 2024, in the Korean Intellectual Property Office, the entire disclosure of which is incorporated herein by reference.

### BACKGROUND

### 1. Field

The present disclosure relates to an apparatus or a connector for connecting electric lines.

### 2. Description of Related Art

An electrical connection apparatus, for example, a connector, is a type of electrical component required for an electrical connection between separate electrical components, circuit boards, electrical devices, etc. There are numerous fields in which an electrical connection apparatus is used. For example, an electrical connection apparatus is used in a battery management system (BMS) that controls secondary batteries included in applications such as electric vehicles or an energy storage system (ESS) to perform optimally and protects them against failures, fires, etc.

A circuit board, often referred to as a printed circuit board (PCB) or a printed wiring board (PWB), is an electrical component that connects circuit elements easily and accurately by printing or attaching conductive patterns made of copper or aluminum on a surface of an insulating board. The design of conductive patterns on an insulating board is referred to as PCB artwork. One important factor to consider in PCB artwork is to ensure that the conductive patterns have their own independent paths in a two-dimensional flat surface without twisting or intersecting.

However, when a large number of pins are positioned in a narrow area, such as in an electrical connection apparatus, there are many cases where the conductive patterns need to be twisted or intersected. When a conductive pattern needs to be intersected or twisted as the PCB artwork is performed, jump wires are added or a separate relay is used. But such an arrangement is disadvantageous in terms of cost, time, and product size.

The above information disclosed in this section is for enhancement of understanding of the background of the present disclosure. It may contain information that does not constitute a related or prior art.

### SUMMARY OF THE DISCLOSURE

The present disclosure is directed to a method of solving the above-described problems within an electrical connection apparatus, thereby facilitating design of a conductive pattern during artwork on a circuit board and maximizing space utilization.

According to an aspect of the present disclosure, there is provided an electrical connection apparatus including a plurality of pins configured to be inserted into holes formed in a circuit board, a plurality of terminals electrically connected to the plurality of pins, a housing supporting the pins and the terminals, and a pin connection conductor electrically connecting two or more pins of the pins.

According to another aspect of the present disclosure, there is provided an electrical connection apparatus including a plurality of first row pins and a plurality of second row pins that are configured to be inserted into holes formed in a circuit board and are formed in two rows, a plurality of first row terminals and a plurality of second row terminals disposed in two rows and electrically connected to the plurality of pins, a housing supporting the first and second row pins and the first and second row terminals, a first row pin connection conductor electrically connecting two or more of the first row pins, and a second row pin connection conductor electrically connecting two or more of the second row pins.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The drawings illustrate embodiments of the present disclosure and describe aspects and features of the present disclosure together with the detailed description of the present disclosure. The present disclosure is not limited to the embodiments depicted in the drawings.

FIGS. 1A and 1B are front and back perspective views of a typical connector;

FIGS. 2A and 2B illustrate an example of a circuit board, wherein FIG. 2A shows a first surface of the circuit board and FIG. 2B shows a second surface of the circuit board;

FIGS. 3 and 4 illustrate an electrical connection apparatus according to embodiments of the present disclosure, wherein FIG. 3 is an overall perspective view, and FIG. 4 is a detailed view of portion A of FIG. 3;

FIG. 5 illustrates a pin connection conductor according to embodiments of the present disclosure;

FIG. 6 illustrates a fixing portion of a pin connection conductor according to embodiments of the present disclosure;

FIG. 7 illustrates a shape of the contactor of the pin connection conductor;

FIG. 8 illustrates an electrical connection apparatus according to embodiments of the present disclosure of the present disclosure;

FIG. 9 illustrates a secondary battery pack in which the electrical connection apparatus of the present disclosure is used; and

FIG. 10 illustrates a vehicle in which the secondary battery pack is mounted.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. In addition, the same reference numerals may be assigned to the same components in different embodiments.

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

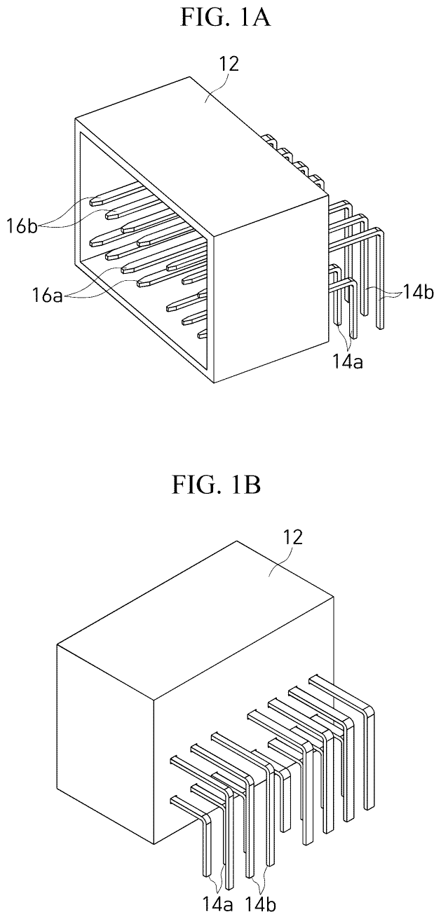

FIGS. 1A and 1B are front and back perspective views of a connector that is a typical electrical connection apparatus. The electrical connection apparatus includes a housing 12, pins 14a and 14b, and terminals 16a and 16b.

The housing 12 forms the exterior of the electrical connection apparatus and is formed in various shapes and from various materials. The housing 12 shown in FIGS. 1A and 1B constitutes the housing of a female connector (in other words, a receptacle, a socket, etc.) having a shape into which another connector is inserted.

The pins 14a and 14b are connected to other circuit components by being inserted into holes formed in a circuit board or by being bonded to lead wires. In FIGS. 1A and 1B, the pins 14a and 14b include first layer pins 14a and second layer pins 14b, which form two layers vertically.

The terminals 16 are connected to a terminal of a male connector that is an opposite connector (referred to also as a plug). In FIGS. 1A and 1B, the terminals 16a and 16b include first layer terminals 16a and second layer terminals 16b, which form two layers vertically.

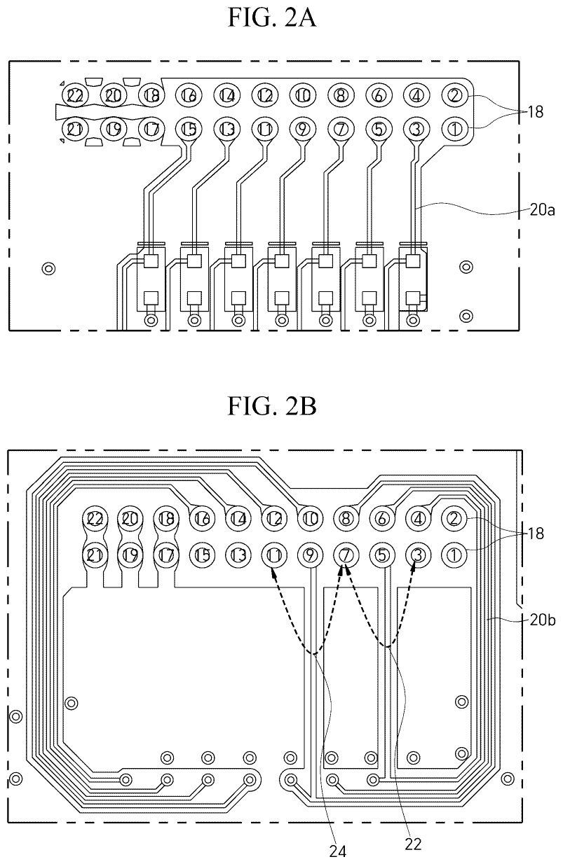

FIGS. 2A and 2B illustrate an example of a circuit board, wherein FIG. 2A shows a first surface of the circuit board and FIG. 2B shows a second surface of the circuit board.

Holes 18 are formed in the circuit board, with the holes 18 being configured to receive the pins 14a and 14b of the connector. Conductive patterns 20a and 20b for connecting lands formed around the holes 18 to other circuit elements are formed.

Since the connector typically has many of the pins 14a and 14b disposed in a relatively narrow area, many of the pin insertion holes 18 may be formed in the circuit board with short distances between the holes 18. Accordingly, when substrate artwork is performed, it is inevitable that conductive patterns may intersect or become twisted with other conductive patterns. In FIG. 2B, intersecting or twisting patterns are indicated by reference numerals 22 and 24.

When PCB artwork is performed in cases where conductive patterns 22 and 24 are intersected or twisted, jump wires should be added or a separate relay board should be used. But such an arrangement is disadvantageous in terms of cost, time, and space utilization.

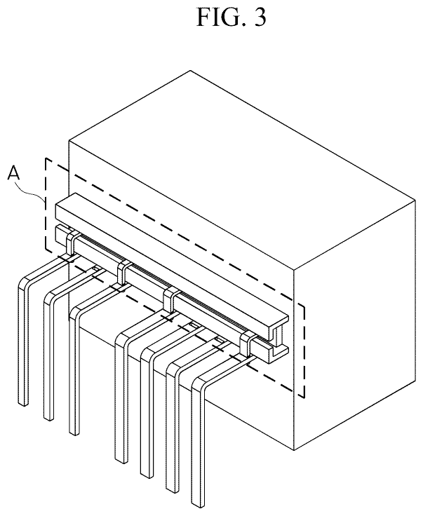

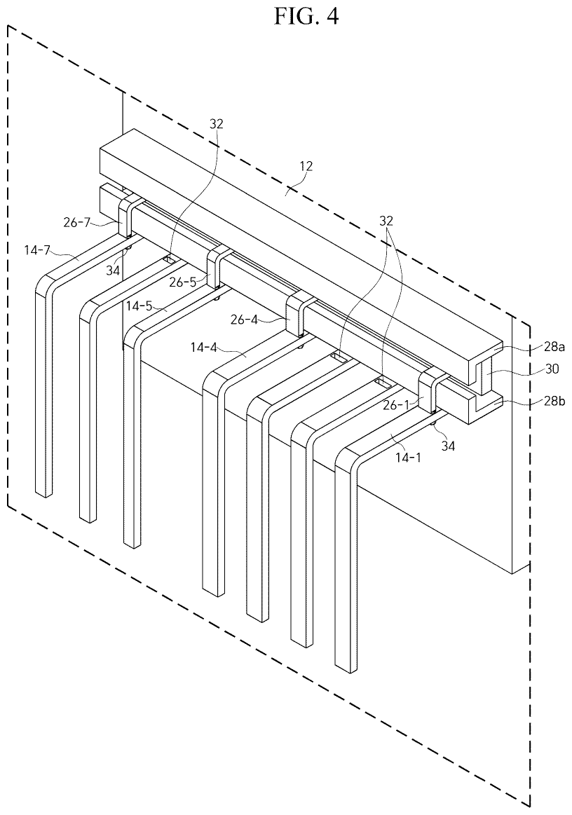

FIGS. 3 and 4 show a connector that is the electrical connection apparatus according to embodiments of the present disclosure. FIG. 3 is an overall perspective view, and FIG. 4 is a detailed view of portion A of FIG. 3.

In the illustrated electrical connection apparatus, pin connection conductors are added to electrically connect some pins 14-1, 14-4, 14-5, and 14-7 among the plurality of pins attached to the housing 12. The pin connection conductors include contactors 26-1, 26-4, 26-5, and 26-7 in contact with the four pins 14-1, 14-4, 14-5, and 14-7 among the seven pins, and a plate 30 to which the contactors 26-1, 26-4, 26-5, and 26-7 are attached and which electrically connect the contactors 26-1, 26-4, 26-5, and 26-7. With the electrical connection apparatus depicted in FIGS. 3 and 4, as shown in FIG. 2B there is no need to draw an intersecting pattern on the circuit board because the pins are connected using the pin connection conductors at the connector.

As shown in FIG. 4, through-holes 32 are formed in the pins. The contactors 26-1, 26-4, 26-5, and 26-7 are inserted into the through-holes 32 so that end portions 34 of the contactors protrude from the through-holes 32.

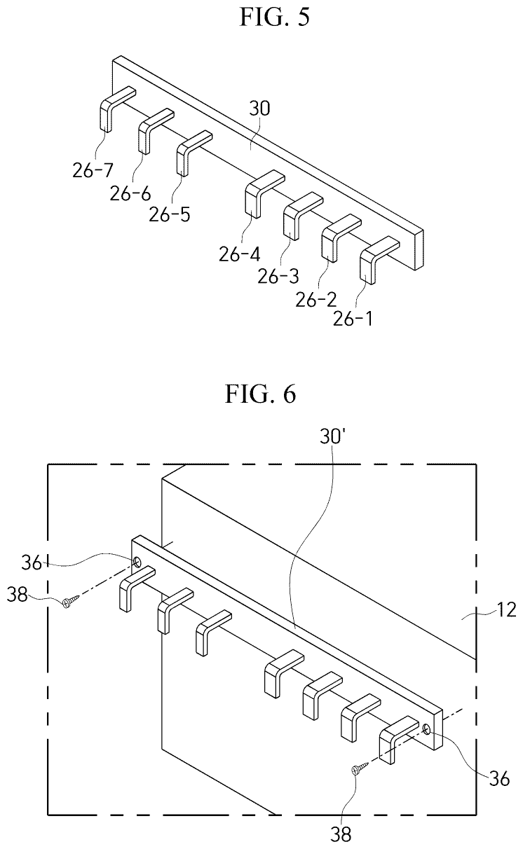

FIG. 5 illustrates a pin connection conductor according to embodiments. The seven contactors 26-1 to 26-7 are attached to the conductor plate 30. Here, the seven contactors 26-1 to 26-7 may correspond to the seven pins 14-1 to 14-7 of the connector show in FIG. 4.

A manufacturer of the connector may provide the pin connection conductor in the shapes such as that illustrated in the drawings. A user removes the contactors from the provided pin connection conductors so as to leave only desired contactors (e.g., the contactors 26-1, 26-4, 26-5, and 26-7 of FIG. 4), thereby interconnecting desired pins (e.g., the pins 14-1, 14-4, 14-5, and 14-7 of FIG. 4) and the desired contactors. The contactors may be removed by being cut using a nipper or a cutter or by being repeatedly bent until they are broken.

Referring to FIG. 4 again, the pin connection conductor may be fixed to the housing 12. To fix the pin connection conductor to the housing 12, a pin connection conductor fixing part for fixing the pin connection conductor to the housing 12 may be provided.

According to one example of the pin connection conductor fixing part shown in FIG. 4, a pair of rails 28a and 28b may be provided in parallel alongside the disposed pins. Through the rails, the plate 30 of the pin connection conductor may slide to be fixed to or removed from the housing 12.

FIG. 6 shows another example of the pin connection conductor fixing part. In this embodiment, screw fastening holes 36 for attaching the plate 30′ to the housing 12 with screws 38 are formed in the plate 30′. The screw fastening holes 36 may be formed as long holes for adjusting a position of the plate 30′.

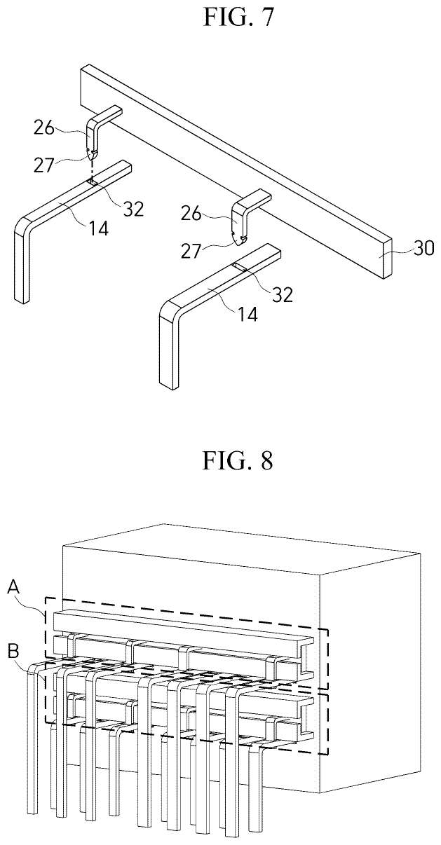

FIG. 7 illustrates a method of firmly contacting the contactor 26 of the pin connection conductor to the pin 14. The contactor 26 includes a front end portion 27 in the form of a hook or barb. The front end portion 27 is inserted the through-hole formed in a corresponding pin 14. When the front end portion 27 of the contactor 26 is inserted into the through-hole 32 of the pin 14, the front end portion 27 may be firmly maintained and not easily pulled out due to a hook shape.

FIG. 8 illustrates an electrical connection apparatus according to other embodiments of the present disclosure. In this embodiment, a second row of pins are added, and, thus, the pin connection conductor and a fixing portion B thereof are added. Thus, the electrical connection apparatus of FIG. 8 includes a plurality of first row pins and a plurality of second row pins inserted into holes formed in two rows in the circuit board. The electrical connection apparatus also includes a plurality of first row terminals and a plurality of second row terminals disposed in two rows and electrically connected to the plurality of pins, a housing supporting the first and second row pins and the first and second row terminals, a first row pin connection conductor electrically connecting two or more pins among the first row pins, and a second row pin connection conductor electrically connecting two or more pins among the second row pins.

In FIG. 8, the first row pin connection conductor and related members indicated by portion A and the second row pin connection conductor and related members indicated by portion B are the same. But the present disclosure is not limited to such a configuration. For example, the pin connection conductor having the structure shown in FIGS. 4 and 5 used in portion A, and the pin connection conductor having the structure shown in FIG. 6 used in portion B. In addition, as described above (see FIG. 4), the first row pin connection conductor of portion A may connect the four pins 14-1, 14-4, 14-5, and 14-7 to each other using the four contactors 26-1, 26-4, 26-5, and 26-7, but the second row pin connection conductor of portion B may leave all the pins independent without the contactors.

The first row pin connection conductor and the related structure of portion A and the second row pin connection conductor and the related structure of portion B are the same as described above. Thus, a further detailed description thereof will be omitted.

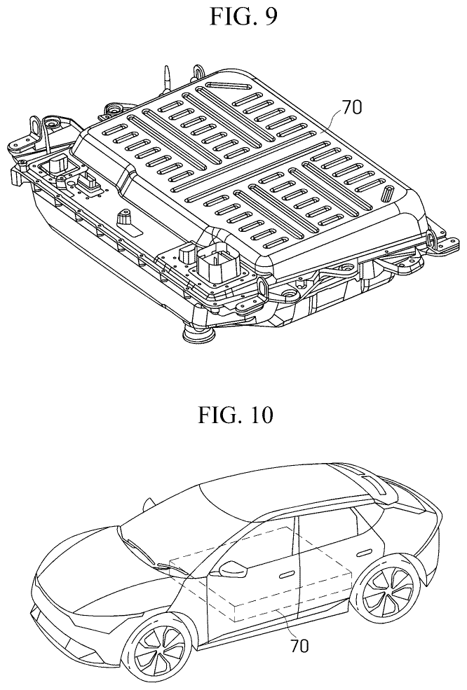

FIG. 9 illustrates a secondary battery pack in which the electrical connection apparatus of the present disclosure is used.

A secondary battery pack 70 may be manufactured by embedding a plurality of secondary battery modules into a pack housing designed to be mounted in an actual product (e.g., a vehicle). The pack housing may include a fastening part necessary for mounting in the product, and an electrical connection apparatus. The secondary battery pack may include a secondary battery and a battery management system (BMS) for managing the secondary battery. The BMS measures and predicts a voltage (V), a current (I), and a temperature (T) of a secondary battery installed in an electric vehicle or energy storage system (ESS) through sensors in advance and controls the secondary battery to exhibit optimal performance. The BMS may include a detection device, a balancing device, and a control device.

FIG. 10 illustrates a vehicle in which the secondary battery pack is mounted. The vehicle may be, for example, an electric vehicle, a hybrid vehicle, or a plug-in hybrid vehicle. The vehicle may be a four-wheel drive or two-wheel drive vehicle. FIG. 10 illustrates the secondary battery pack 70 mounted in a lower portion of a vehicle body of the vehicle.

According to embodiments of the present disclosure, intersecting or twisting of conductive patterns on a circuit board can be prevented by changing an internal structure of an electrical connection apparatus. Thus, there is no need for additional jump wires or separate relay boards, a cost increase factor can be eliminated, and printed circuit board artwork is simplified so that benefits of shortening a design time, increasing space utilization, and minimizing a probability of errors can be achieved.

In addition, according to the present disclosure, an effect of being able to not only prevent the intersecting or twisting of the conductive patterns, but also simplify or omit a connection path of the conductive patterns is obtained.

Although the present disclosure has been described above with respect to embodiments thereof, the present disclosure is not limited thereto. Various modifications and variations can be made thereto by those skilled in the art within the spirit of the present disclosure.

What is claimed is:

1. An electrical connection apparatus comprising:
a plurality of pins configured to be inserted into holes formed in a circuit board;
a plurality of terminals electrically connected to the plurality of pins;
a housing supporting the pins and the terminals; and
a pin connection conductor electrically connecting two or more of the pins.

2. The electrical connection apparatus as claimed in claim 1, wherein the pin connection conductor comprises:
a plurality of contactors in contact with two or more of the pins; and
a plate electrically connecting the contactors.

3. The electrical connection apparatus as claimed in claim 2, wherein the contactors are removably attached to the plate.

4. The electrical connection apparatus as claimed in claim 2, wherein each of the contactors each comprise a front end portion having a hook shape that extends through a corresponding pin of the pins and thereby fix the front end portion to the pin.

5. The electrical connection apparatus as claimed in claim 4, wherein each of the pins include a hole into which the front end portion of one of the contactors is inserted.

6. The electrical connection apparatus as claimed in claim 1, wherein the pin connection conductor is attached to the housing.

7. The electrical connection apparatus as claimed in claim 1, wherein the pin connection conductor comprises a screw fastening hole, and
wherein a screw is provided in the screw fastening hole to attach the pin connection conductor to the housing.

8. The electrical connection apparatus as claimed in claim 1, wherein the housing comprises a pin connection conductor fixing part to which the pin connection conductor is fixed.

9. The electrical connection apparatus as claimed in claim 8, wherein the pin connection conductor fixing part of the housing comprises a rail along which the pin connection conductor is slidable such that the pin connection conductor can be fixed to or removed from the housing.

10. An electrical connection apparatus comprising:
a plurality of first row pins and a plurality of second row pins that are configured to be inserted into holes formed in a circuit board and are formed in two rows;
a plurality of first row terminals and a plurality of second row terminals disposed in two rows and electrically connected to the plurality of pins;
a housing supporting the first and second row pins and the first and second row terminals;
a first row pin connection conductor electrically connecting two or more of the first row pins; and
a second row pin connection conductor electrically connecting two or more of the second row pins.

11. The electrical connection apparatus as claimed in claim 10, wherein at least one of the first row pin connection conductor and the second row pin connection conductor includes:
a plurality of contactors in contact with two or more of that pins; and
a plate configured to electrically connect the contactors.

12. The electrical connection apparatus as claimed in claim 11, wherein the contactors are removably attached to the plate.

13. The electrical connection apparatus as claimed in claim 11, wherein the contactors each comprise a front end portion having a hook shape that extends through one of the first row pins or second row pins to thereby fix the front end portion to the pin.

14. The electrical connection apparatus as claimed in claim 13, wherein each of the front row pins and the second row pins comprises a hole into which a front end portion one of the contactors is inserted.

15. The electrical connection apparatus as claimed in claim 10, wherein the first row pin connection conductor and the second row pin connection conductor are attached to the housing.

16. The electrical connection apparatus as claimed in claim 10, wherein at least one of the first row pin connection conductor and the second row pin connection conductor comprises a screw fastening hole, and
wherein a screw is inserted through the screw fastening hole to attach the at least one of the first row pin connection conductor and the second row pin connection conductor to the housing.

17. The electrical connection apparatus as claimed in claim 10, wherein the housing comprises a pin connection conductor fixing part to which at least one of the first row pin connection conductor and the second row pin connection conductor is fixed.

18. The electrical connection apparatus as claimed in claim 17, wherein the pin connection conductor fixing part comprises a rail along which at least one of the first row pin connection conductor and the second row pin connection conductor is slidable such that at least one of the first row pin connection conductor and the second row pin connection conductor may be fixed to or removed from the housing.
